(19) United States
(12) Patent Application Publication
(10) Pub. No.: US 2024/0204613 A1
(43) Pub. Date: Jun. 20, 2024

(54) Fan and Stator Thereof

(71) Applicant: VAST GLORY ELECTRONIC & HARDWARE & PLASTIC (HUI ZHOU) LTD, Hui Zhou City (CN)

(72) Inventors: Shi-Man Xu, Hui Zhou City (CN); Jia-Sheng LAI, Hui Zhou City (CN)

(21) Appl. No.: 18/168,641

(22) Filed: Feb. 14, 2023

(30) Foreign Application Priority Data
Dec. 19, 2022 (CN) 202211635210.9

(51) Int. Cl. H02K 7/14; H02K 1/14

(52) U.S. Cl. CPC H02K 7/14; H02K 1/14; H02K 2203/03

(57) ABSTRACT

A fan has a frame, a stator, a fan blade, and a rotor. The stator is mounted in the frame and has a core assembly, a circuit board, and a coil winding. The core assembly has a first engaging structure. The circuit board is connected to the core assembly and has a second engaging structure and multiple conducting protrusions. The second engaging structure engages with the first engaging structure of the core assembly, and the conducting protrusions protrude from a dip-soldering edge of the circuit board. The coil winding is mounted to the core assembly and has multiple end segments, and each of the end segments is wrapped around a respective one of the conducting protrusions of the circuit board. The fan blade is rotatably mounted in the frame. The rotor is mounted in the fan blade and surrounds the stator.

### BACKGROUND OF THE INVENTION 2

### 1. Field of the Invention

The present invention relates to a fan and a stator of the fan.

### 2. Description of the Prior Arts

With reference to FIG. 8, a common cooling fan 90 has a conventional stator 91, a frame 92, a fan blade 93, and a rotor (not shown in figures). The stator 91 is fixed to a central part of the frame 92. The fan blade 93 is rotatably mounted in the frame 92. The rotor is a ring-shaped magnet that is fixed inside a hub of the fan blade 93, surrounds the stator 91, and is configured to drive the fan blade 93 to rotate.

With reference to FIGS. 6 and 7, the conventional stator 91 has a core assembly 911, three pins 912, a coil winding 913, and a circuit board 914. The conventional stator 91 is assembled according to the following steps.

Step 1: insert the pins 912 through the core assembly 911 and then wind end segments 9131 of the coil winding 913 around top ends of the pins 912, wherein the coil winding 913 is one or multiple enamel wires coiled about the core assembly 911.

Step 2: coat the top ends of the pins 912 with soldering flux, and then turn over the core assembly 911 and dip the end segments 9131 into hot molten solder to fix the end segments 9131 to the pins 912.

Step 3: align and insert the three pins 912 into three vias 9141 of the circuit board 914 respectively and then solder the pins 912 to the circuit board 914 in the vias 9141 to fix the circuit board 914 onto a side of the core assembly 911 and to electrically connect the coil winding 913 to the circuit board 914.

However, the conventional stator 91 has too many components to be assembled and an assembling process of the conventional stator 91 is time-consuming and laborious. Additionally, the soldering flux easily flows downward into the coil winding 913 via the end segment 9131, thereby undermining performance and reliability of the conventional stator 91.

To overcome the shortcomings, the present invention provides a fan and a stator of the fan to mitigate or obviate the aforementioned problems.

### SUMMARY OF THE INVENTION

The main objective of the present invention is to provide a fan and a stator thereof, wherein a circuit board of the stator is configured to engage directly with a core assembly, and the circuit board is configured to be wrapped around directly by end segments of a coil winding to simplify assembly procedure.

The stator for the fan has a core assembly, a circuit board, and a coil winding. The core assembly has a first engaging structure. The circuit board is connected to the core assembly and has a second engaging structure and multiple conducting protrusions. The second engaging structure engages with the first engaging structure of the core assembly, and the conducting protrusions protrude from a dip-soldering edge of the circuit board. The coil winding is mounted to the core assembly and has multiple end segments, and each of the end segments is wrapped around a respective one of the conducting protrusions of the circuit board.

The fan has a frame, the stator as mentioned above, a fan blade, and a rotor. The stator is mounted in the frame and has a core assembly, a circuit board, and a coil winding. The core assembly has a first engaging structure. The circuit board is connected to the core assembly and has a second engaging structure and multiple conducting protrusions. The second engaging structure engages with the first engaging structure of the core assembly, and the conducting protrusions protrude from a dip-soldering edge of the circuit board. The coil winding is mounted to the core assembly and has multiple end segments, and each of the end segments is wrapped around a respective one of the conducting protrusions of the circuit board. The fan blade is rotatably mounted in the frame. The rotor is mounted in the fan blade and surrounds the stator.

To assemble the stator, engage the first engaging structure and the second engaging structure to fix the circuit board to the core assembly, and then wrap the end segments of the coil winding around the conducting protrusions of the circuit board. Finally, weld the end segments to the conducting protrusions to electrically connect the coil winding to the circuit board.

The advantage of the present invention is that the second engaging structure formed by the circuit board itself has the same function as conventional pins in terms of structural connection, while the conducting protrusions have the same function as the conventional pins in terms of electrical connection. As a result, pins and pin-related assembly steps are omitted in the present invention, thereby simplifying assembly procedure and reducing assembly time.

Moreover, because the end segments of the coil winding are wrapped around the conducting protrusions of the circuit board, the end segments are disposed on an edge of the stator instead of being disposed on a top of the stator, thereby preventing soldering flux from flowing into the coil winding; by preventing soldering flux from entering into the coil winding, an insulating surface layer of the coil winding is no longer eroded by the soldering flux, thereby improving performance and reliability of the stator.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a stator in accordance with the present invention;

FIG. 2 is a another perspective view of the stator in FIG. 1;

FIG. 3 is an exploded perspective view of the stator in FIG. 1;

FIG. 4 is an enlarged schematic sectional view of a fan with the stator in FIG. 1;

FIG. 5 is a schematic perspective view of the fan in FIG. 4;

FIG. 6 is a perspective view of a conventional stator in accordance with the prior art;

FIG. 7 is another perspective view of the conventional stator in FIG. 6; and

FIG. 8 is a schematic perspective view of a conventional fan with the conventional stator in FIG. 6.

### DETAILED DESCRIPTION OF THE PREFERRED EMBODIMENTS

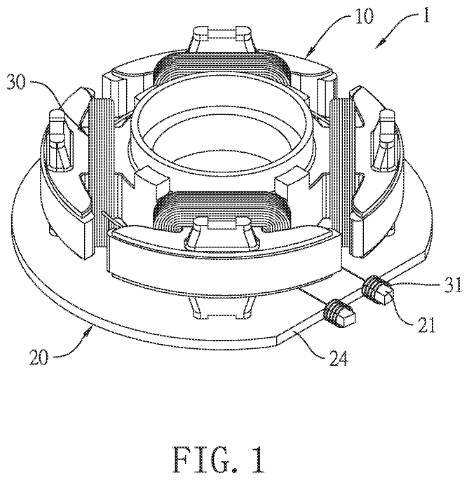

With reference to FIGS. 1, 4, and 5, a fan in accordance with the present invention comprises a stator 1, a frame 81, a fan blade 82, and a rotor 83.

The stator 1 is mounted in the frame 81, and to be precise, the stator 1 is fixed in the frame 81. The stator 1 has a core assembly 10, a circuit board 20, and a coil winding 30.

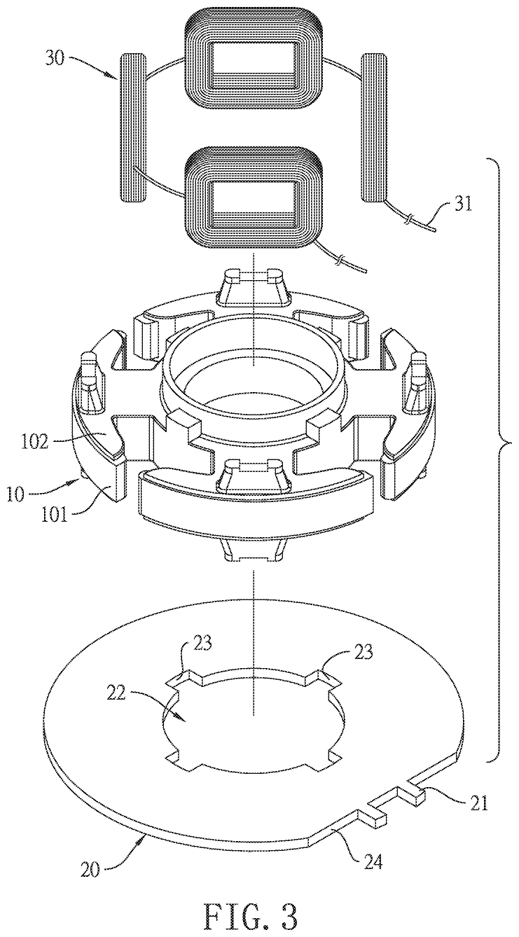

With reference to FIGS. 1 to 3, the core assembly 10 has a first engaging structure. The first engaging structure preferably has multiple hooks 11. In the preferred embodiment, the core assembly 10 has a metal part 101 and a plastic part 102. The metal part 101 is preferably made of silicon steel laminations. The plastic part 102 is wrapped around the metal part 101 and is preferably made by overmolding. The plastic part 102 forms the hooks 11.

The circuit board 20 is connected to the core assembly 10. The circuit board 20 has a second engaging structure and multiple conducting protrusions 21, and an assembly hole 22 is preferably formed through the circuit board 20. The second engaging structure engages with the first engaging structure of the core assembly 10.

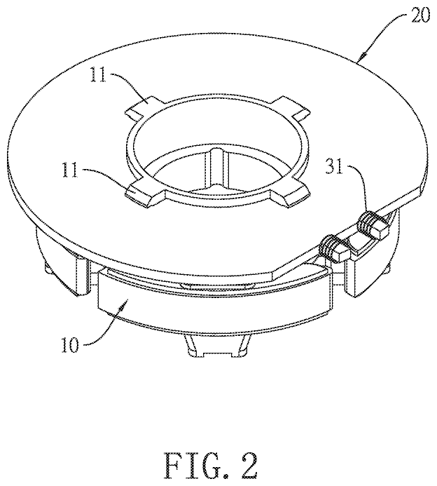

With reference to FIGS. 2 to 4, in the preferred embodiment, the second engaging structure has multiple engaging recesses 23. The engaging recesses are formed in a periphery defined around the assembly hole 22 and disposed around a center of the assembly hole 22.

Each of the hooks 11 of the core assembly 10 is mounted through a respective one of the engaging recesses 23 of the circuit board 20 and abuts against a periphery of the respective one of the engaging recesses 23 to engage the circuit board 20 with the core assembly 10. Meanwhile, the hooks 11 are constrained by side walls of the engaging recesses 23 to prevent lateral movement of the hooks 11, thereby fixing a relative angular position between the circuit board 20 and the core assembly 10. Here “fixing an angle between the circuit board 20 and the core assembly 10” means preventing the circuit board 20 from rotating relative to the core assembly 10.

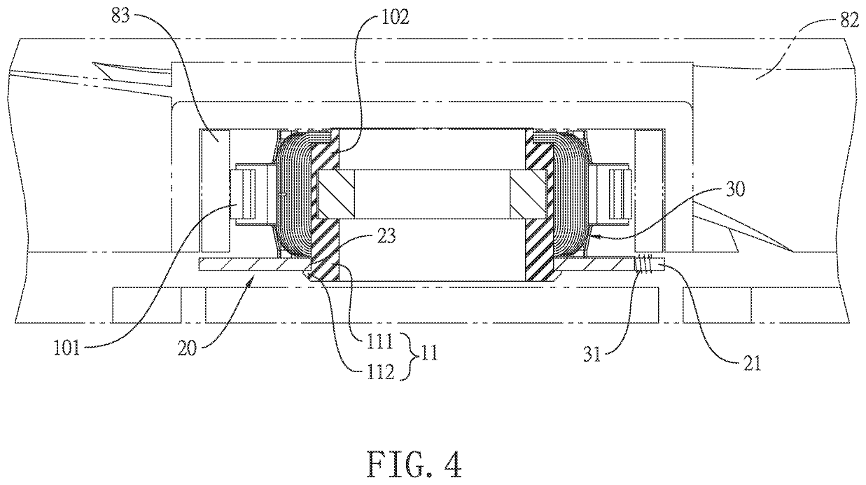

To be specific, each of the hooks 11 of the core assembly 10 has a neck portion 111 (as shown in FIG. 4) and a snap protrusion 112 (as shown in FIG. 4). The neck portion 111 is mounted through the respective engaging recess 23 of the circuit board 20, and the snap protrusion 112 hooks the periphery of the respective engaging recess 23 to fix the circuit board 20 on a side of the core assembly 10.

The conducting protrusion 21 protrudes from a dip-soldering edge 24 of the circuit board 20. The dip-soldering edge 24 is preferably linear; that is, the dip-soldering edge 24 preferably extends along a straight line. The conducting protrusion 21 is formed by cutting the circuit board 20, and a circuit (not shown in figures) of the circuit board 20 extends to the conducting protrusion 21.

The coil winding 30 is mounted to the core assembly 10 and has multiple end segments 31. Each of the end segments 31 is wrapped around a respective one of the conducting protrusions 21 of the circuit board 20 to electrically connect the coil winding 30 to the circuit of the circuit board 20. The coil winding 30 is formed by wrapping enamel wires around the core assembly 10. A structure of the coil winding 30 is same as a standard conventional coil winding, and therefore detailed description of the coil winding 30 is omitted.

To assemble the stator 1, engage the circuit board 20 with the core assembly 10 via the hooks 11, and then wrap the end segments 31 of the coil winding 30 around the conducting protrusions 21 of the circuit board 20. Finally, dip the conducting protrusions 21 into molten solder with the dip-soldering edge 24 facing downward such that the molten solder breaks an insulating surface layer covering the enamel wires and solder the end segments to the conducting protrusion 21 and electrically connect the coil winding 30 to the circuit board 20.

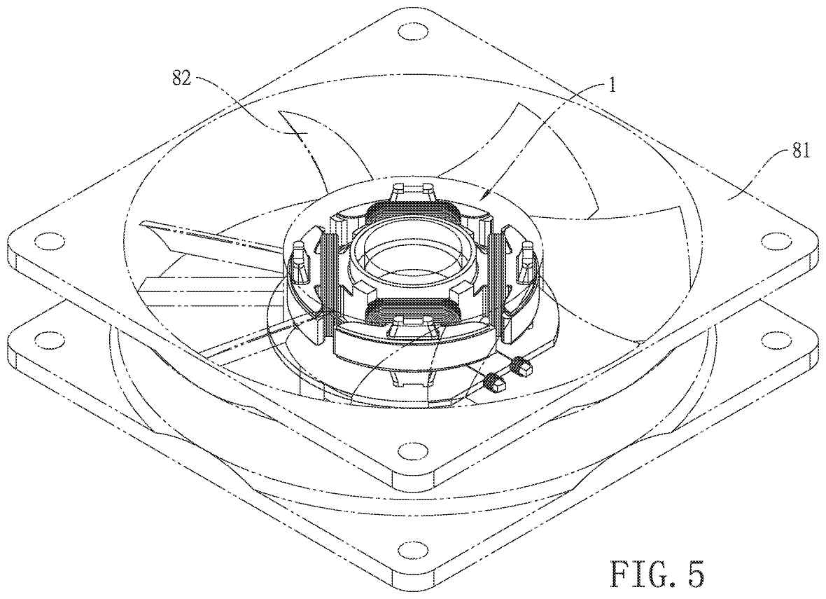

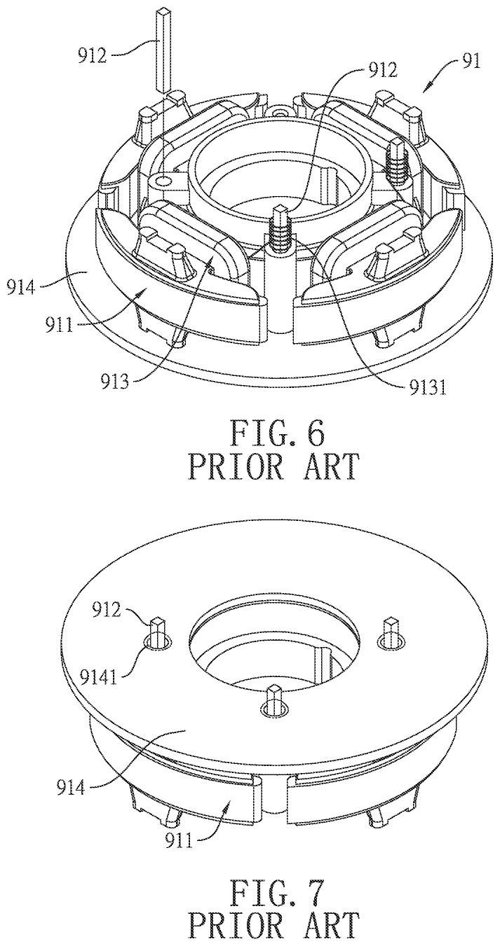

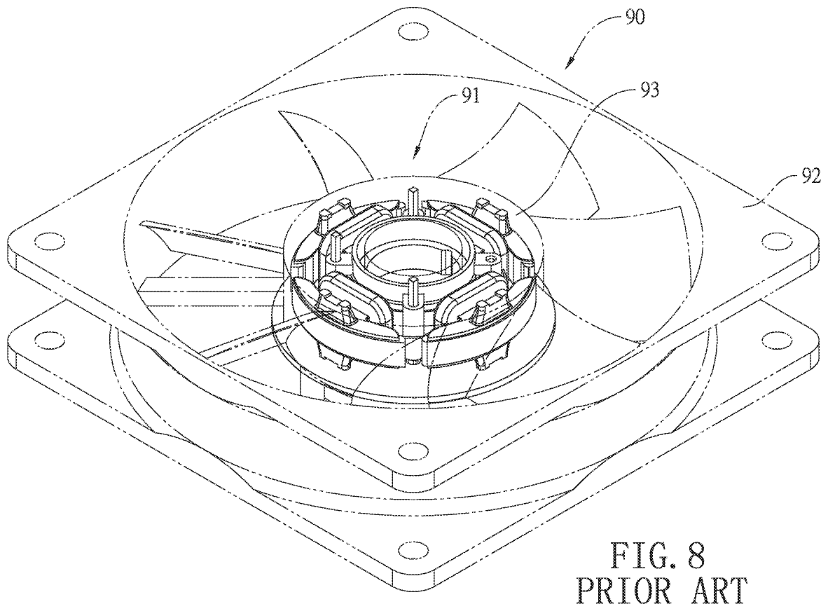

With reference to FIGS. 4 and 5, the fan blade 82 is rotatably mounted in the frame 81. The rotor 83 is a ring-shaped magnet fixed inside a hub of the fan blade 93 and surrounding the stator 10. When powered, current enters the coil winding 30 via the circuit board 20 and rotates the fan blade 93 through the rotor 83. The fan is preferably a cooling fan for computers.

In summary, the second engaging structure formed by the circuit board itself has the same function as conventional pins in terms of structural connection, while the conducting protrusions 21 have the same function as the conventional pins in terms of electrical connection. As a result, pins and pin-related assembly steps are omitted in the present invention, thereby simplifying assembly procedure and reducing assembly time, and also improving performance and reliability of the stator 1.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A stator for a fan, the stator comprising:
a core assembly having a first engaging structure;
a circuit board connected to the core assembly and having:
a second engaging structure enraging with the first engaging structure of the core assembly; and
multiple conducting protrusions protruding from a dip-soldering edge of the circuit board; and
a coil winding mounted to the core assembly and having multiple end segments; each of the end segments wrapped around a respective one of the conducting protrusions of the circuit board.

2. The stator as claimed in claim 1, wherein the first engaging structure of the core assembly has multiple hooks, and the hooks hook the second engaging structure of the circuit board.

3. The stator as claimed in claim 2, wherein:
the circuit board has an assembly hole;
the second engaging structure has multiple engaging recesses, and the engaging recesses are formed in a periphery defined around the assembly hole; and
each of the hooks of the core assembly hooks a respective one of the engaging recesses of the circuit board to fix a relative angular position between the circuit board and the core assembly.

4. The stator as claimed in claim 2, wherein the dip-soldering edge of the circuit board is linear.

5. The stator as claimed in claim 3, wherein the dip-soldering edge of the circuit board is linear.

6. The stator as claimed in claim 2, wherein the core assembly has:
a metal part; and
a plastic part wrapped around the metal part and forming the hooks of the first engaging structure.

7. The stator as claimed in claim 5, wherein the core assembly has:
a metal part; and
a plastic part wrapped around the metal part and forming the hooks of the first engaging structure.

8. A fan having:
a frame;
a stator mounted in the frame and having:
a core assembly having a first engaging structure;
a circuit board connected to the core assembly and having:
a second engaging structure enraging with the first engaging structure of the core assembly; and
multiple conducting protrusions protruding from a dip-soldering edge of the circuit board; and
a coil winding mounted to the core assembly and having multiple end segments; each of the end segments wrapped around a respective one of the conducting protrusions of the circuit board;
a fan blade rotatably mounted in the frame;
a rotor mounted in the fan blade and surrounding the stator.
